(19) United States
(12) Patent Application Publication
(10) Pub. No.: US 2011/0047492 A1
(43) Pub. Date: Feb. 24, 2011

(54) METHOD AND APPARATUS FOR DISPLAYING FAVORITE CONTACTS

(75) Inventors: Jani Petri Boström, Helsinki (FI); Heli Johanna Musikka, Oulu (FI); Matti Keltanen, Helsinki (FI)

Correspondence Address: DITTHAVONG MORI & STEINER, P.C., 918 Prince Street, Alexandria, VA, 22314, US

(73) Assignee: NOKIA CORPORATION, Espoo (FI)

(21) Appl. No.: 12/706,373

(22) Filed: Feb. 16, 2010

Related U.S. Application Data
(60) Provisional application No. 61/152,893, filed on Feb. 16, 2009.

(51) Int. Cl. G06F 3/01

(52) U.S. Cl. 715/765

(57) ABSTRACT

In accordance with an example embodiment of the present invention, an apparatus, comprising a processor configured to determine whether one or more contacts are identified as a favorite contact. Further, the apparatus comprises a user interface configured to display the identified favorite contacts in one or more contact widgets based at least in part on the determination.

### RELATED APPLICATIONS

This application claims priority to U.S. Application No. 61/152893, titled “METHOD AND APPARATUS FOR DISPLAYING FAVORITE CONTACTS”, filed Feb. 16, 2009, which is hereby incorporated by reference in its entirety. Further, this application is related to: U.S. application Ser. No. 12/112001, titled “METHOD, APPARATUS, AND COMPUTER PROGRAM PRODUCT FOR PROVIDING SERVICE INVITATIONS”, filed Apr. 30, 2008; U.S. application Ser. No. 12/112004, titled “METHOD, APPARATUS, AND COMPUTER PROGRAM PRODUCT THAT PROVIDE FOR PRESENTATION OF EVENT ITEM”, filed Apr. 30, 2008; U.S. application Ser. No. 12/111998, titled “METHOD, APPARATUS, AND COMPUTER PROGRAM PRODUCT FOR PROVIDING USAGE ANALYSIS”, filed Apr. 30, 2008; U.S. application Ser. No. 12/111999, titled “METHOD, APPARATUS, AND COMPUTER PROGRAM PRODUCT FOR DETERMINING USER STATUS INDICATORS”, filed Apr. 30, 2008; U.S. patent application, titled “METHOD AND APPARATUS FOR DISPLAYING CONTACT WIDGETS”, and U.S. patent application Ser. No. 12/236229 filed Sep. 23, 2008; U.S. patent application Ser. No. 12/236242, titled “METHOD AND APPARATUS FOR DISPLAYING UPDATED CONTACT WIDGETS”, filed Sep. 23, 2008. Each of these related applications are hereby incorporated by reference in their entirety.

### TECHNICAL FIELD

The present application relates generally to a method and apparatus for displaying favorite contacts.

### BACKGROUND

A user may use an electronic device and/or a server to communicate with friends, family, or other types of contacts. The electronic device and/or server may provide a user with features to display contact information.

### SUMMARY

In accordance with an example embodiment of the present invention, an apparatus, comprising a processor configured to determine whether one or more contacts are identified as a favorite contact. Further, the apparatus comprises a user interface configured to display the identified favorite contacts in one or more contact widgets based at least in part on the determination.

In accordance with another example embodiment of the present invention, a method, comprising determining whether one or more contacts are identified as a favorite contact and displaying the identified favorite contacts in one or more contact widgets based at least in part on the determination.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting a network for updating contacts in accordance with an example embodiment of the invention;

FIG. 3 is a screen view depicting a contact widget with contact detail in accordance with an example embodiment of the invention;

FIG. 4 is a screen view depicting contact widgets in a screen saver view in accordance with an example embodiment of the invention;

FIG. 5 is a screen view depicting contact widgets in a grid view in accordance with an example embodiment of the invention;

FIG. 6 is a screen view depicting a contact widget in a stacked view in accordance with an example embodiment of the invention;

FIG. 7A is a flow diagram depicting an example method for transferring one or more updated contacts in accordance with an example embodiment of the invention;

FIG. 7B is a flow diagram depicting an example method for displaying one or more updated contacts in accordance with an example embodiment of the invention;

FIG. 8A is a screen view depicting a contact widget in accordance with an example embodiment of the invention;

FIG. 8B is a grid view depicting one or more favorite contact widgets in accordance with an example embodiment of the invention; and

FIG. 9 is a flow diagram depicting an example method for displaying one or more favorite contacts in accordance with an example embodiment of the invention.

### DETAILED DESCRIPTION OF THE DRAWINGS

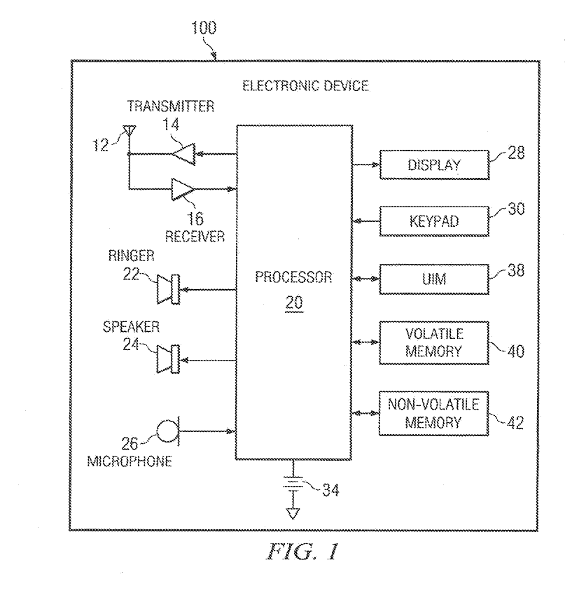

An example embodiment of the present invention and its potential advantages are best understood by referring to FIGS. 1 through 9 of the drawings.

FIG. 1 is a block diagram depicting an electronic device 100 operating in accordance with an example embodiment of the invention. In an example embodiment, an electronic device 100 may comprise at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, the one or more output devices of the user interface may be coupled to the processor 20.

In an example embodiment, the user interface may allow the electronic device 100 to receive or transmit data. For example, the user interface may comprise any of a number of devices configured to receive data, such as a keypad 30, a touch display, other input device, and/or the like. In an embodiment, the keypad 30 may comprise the conventional numeric, e.g., 0-9, and/or related keys, e.g., #, *, other hard and/or soft keys, and/or the like to operate the electronic device 100. In an alternative embodiment, the keypad 30 may comprise a conventional QWERTY keypad arrangement. Further, the keypad 30 may also comprise various soft keys with associated features. If desired, the electronic device 100 may comprise a user interface device, such as a joystick or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that using the communications protocols described above may use signals. The signals may comprise signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

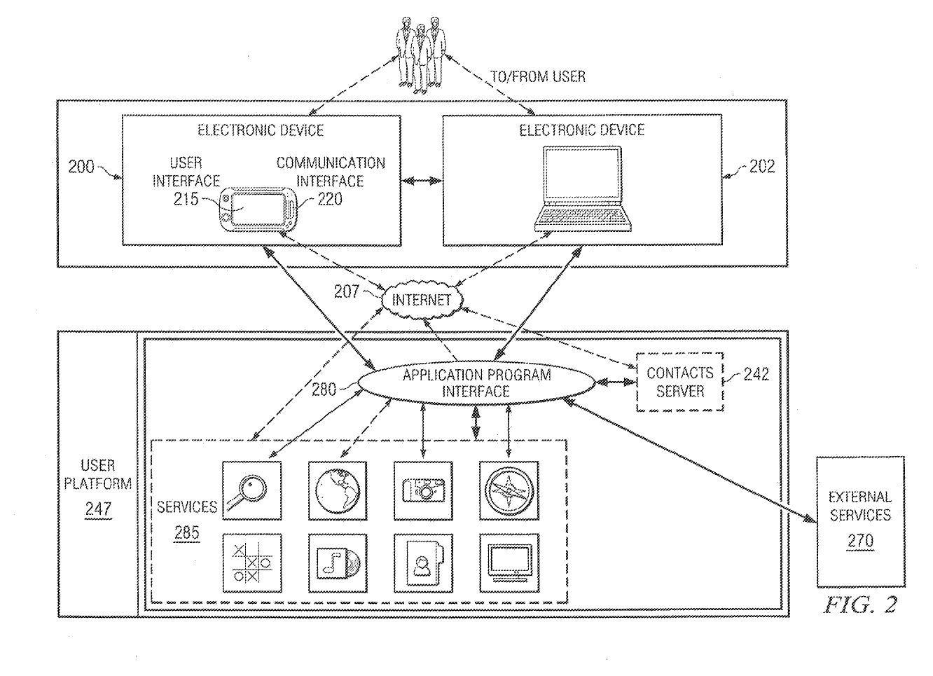

FIG. 2 is a block diagram depicting a network for updating contacts in accordance with an example embodiment of the invention. In an example embodiment, electronic devices 200, 202 may be in communication with a user platform 247, via a network, for example Internet 207. Further, the electronic devices 200, 202 may comprise a user interface, such as user interface 215, a communication interface 220, and/or a processor.

In an example embodiment, a processor, such as processor 20 of FIG. 1, may be configured to execute instructions stored in a memory device of the electronic device 200, such as memory devices 40, 42 of FIG. 1. In an embodiment, the processor may be a microprocessor, various other processing elements, such as an integrated circuit, and/or the like. For example, the processor may be an application specific integrated circuit (ASIC), a field programmable gate array (FPGA), and/or the like.

In an embodiment, the memory device may be configured to buffer input data for processing by the processor. In an alternative embodiment, the memory device may be configured to store instructions for execution by the processor. In another alternative embodiment, the memory device may be one of a plurality of databases. Further, the memory device may store at least one contact widget in real time or otherwise dynamic manner. In an embodiment, the at least one contact widget may comprise one or more of the following information: a mobile number, a name, a short message service contact, a multimedia messaging service contact, an email address, a chat identifier, a location, an Internet protocol address, a voice over Internet protocol client, user profile information, one or more shared files, e.g., documents, photos, media content, and/or the like, or combination thereof, and/or the like. In an embodiment, a widget may be an element of a graphical user interface (GUI). Further, the widget may comprise contact information.

In an example embodiment, user platform 247 may be in communication with electronic devices 200, 202. In an example embodiment, the user platform 247 may comprise one or more services 285, a contacts server 242, and/or an application program interface (API) 280. For example, the contacts server 242 may store one or more contact widgets. In an embodiment, the contacts server 242 may be a web server, database server, file server, and/or the like. Further, the contacts server 242 may comprise a memory device, a processor, and/or a communication interface for communicating over the Internet 207 to, for example communication interface 220 of the electronic device 200.

In an embodiment, the electronic device 200 may use the communication interface 220 to communicate with the contacts server 242, a user platform 247, and/or external services 270 via a network, such as Internet 207. For example, the communication interface 220 may be configured to receive at least one updated contact widget from a server, such as user platform 247, service 285, external services 270, and/or the like. Further, the communication interface 220 may transfer the at least one updated contact widget to electronic device 200 and/or electronic device 202 for synchronization. In an alternative embodiment, the electronic device 200 may communicate or receive the updated contact widget, via the API 280, to the contacts server 242, services 285, external services 270, and/or the like via the Internet 207.

In an embodiment, at least one contact widget may be synchronized between one of the electronic device 200, 202 and the user platform 247 in real time. For example, the contacts server 242 may be configured to synchronize the at least one contact widget when a contact widget has been changed. Further, the contacts server 242 may be configured to update the at least one contact widget in real time. For example, if one contact widget has changed on the electronic device 200, the contacts server 242 may synchronize the at least one contact widget between the contacts server 242 and the electronic device 200 in real time, e.g., as the update occurs. In another embodiment, the services 285 may be configured to synchronize the at least one contact widget when a contact widget has been changed. Further, the services 285 may be configured to update the at least one contact widget in real time. For example, if one contact widget has changed on the contacts server 242, the electronic device 200, or services 285 may synchronize the at least one contact widget between the contacts server 242, services 285, and/or the electronic device 200 in real time. In this way, the electronic device 200, contacts server 242, and/or services 285 maintain substantially the same contact widgets in real time.

In an embodiment, the user interface 215 of the electronic device 200 may be configured to display the at least one contact widget based at least in part on tagging by the processor. In an embodiment, the processor may tag at least one contact widget to be displayed. In an example embodiment, the processor may be configured to tag the at least one contact widget based at least in part on frequency of mobile communication, a group, and/or the like, between the apparatus and a contacts server 242, service, and/or the like. The user interface 215 may be configured to display each tagged contact widget. For example, the user interface 215 may be configured to display the at least one contact widget based at least in part on a tag, e.g., widgets tagged based on frequency of mobile communication. The mobile communication may be at least one of the following: an exchange of short message service, an exchange of multimedia messaging service, a chat, an email, a share of media, a share of location, a game interaction, a combination thereof, and/or the like.

In an example embodiment, the processor may be configured to tag the at least one contact widget based at least in part on the number of mobile communications between the contact and the electronic device 200. In another alternative embodiment the processor may be configured to tag at least one of the contact widgets based at least in part on a group or community of contact widgets. For example, the processor may group contact widgets by a category, such as home, work, and/or the like. In an embodiment, the processor may allow a user to define one or more groups. In this embodiment, the user interface 215 may display the one or more contacts based at least in part on the group.

In an alternative embodiment, the processor may be configured to tag at least one of the at least one contact widget based at least in part on a calendar entry. In an embodiment, the processor may tag at least one contact widget based on an upcoming meeting in a calendar entry. In an alternative embodiment, the processor may consider the priority of the meeting or the like. In yet another alternative embodiment, the processor may be configured to tag a user for display as a contact based at least in part on a calendar entry. For example, the processor may tag the user for display for two days, e.g., the meeting period and the day after for follow up discussion.

It should be understood that a tag may provide a unique representation to the contact widget to indicate the at least one contact widget may be displayed. It should be further understood that the processor may be configured to lock a status of at least one contact widget on the user interface. In an embodiment, the user interface will display the one or more locked contact widgets regardless of the tag.

In an embodiment, the user platform 247 may be used to facilitate storing, retrieving, computing, transmitting, receiving, and/or the like, at least one contact widget. Further, the user platform 247 may be embodied as an electronic device, such as the electronic device 100 of FIG. 1, the electronic device 200, the electronic device 202, and/or the like. The user platform 247 may also be configured to communicate with one or more users using the contact widgets. For example, the user platform 247 may be configured to allow a user of electronic device 200 to contact a second user via a communication, messaging system, communications protocol, and/or the like, e.g., emails, multimedia messaging service (MMS), short message service (SMS) messages, phone calls, and/or the like, using contact information in the contact widget. It should be understood that MMS may be a messaging system, which may allow a user to send messages comprising multimedia objects, e.g., images, audio, video, rich text. Further, a SMS may be a communications protocol to allow the interchange of short text messages between electronic devices.

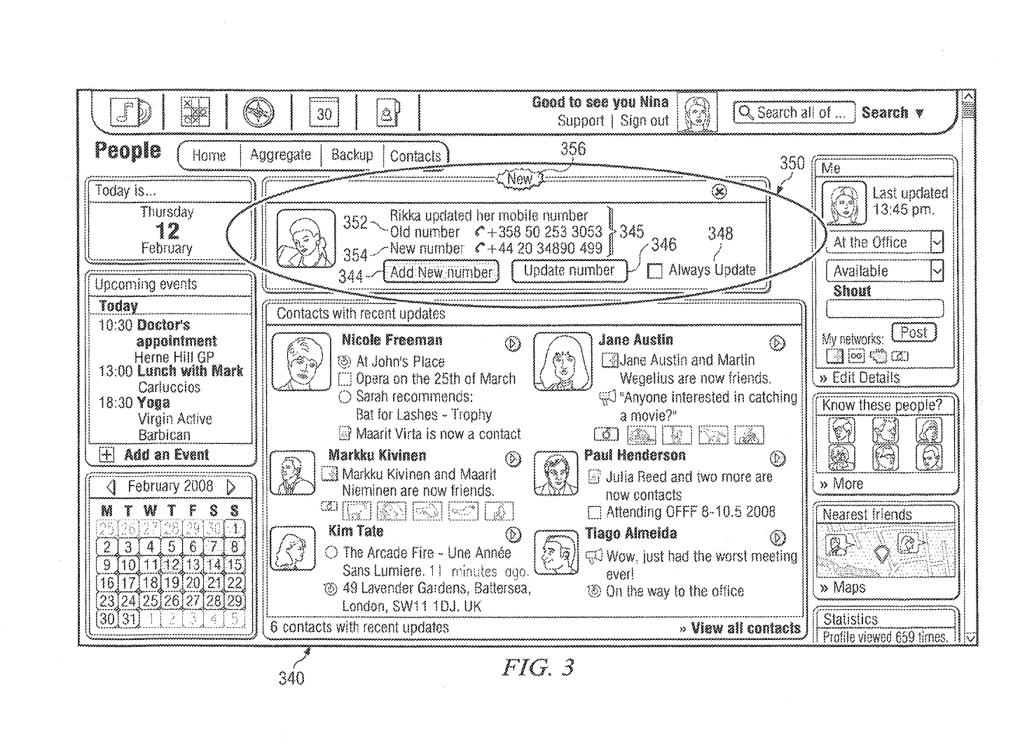

FIG. 3 is a screen view depicting a contact widget 350 with contact detail 345 in accordance with an example embodiment of the invention. In an example embodiment, the user interface 340 may be configured to display information for the contact widget 350 in real time, e.g., based at least in part on updates. For example, the user interface 340 may display the contact widget 350 with contact detail 345 if the contact widget 350 is updated on a contacts server, an electronic device, a service, and/or the like. Further, the user interface 340 may comprise any number of keys, such as an add number key 344, an update number key 346, always update key 348, and/or the like.

In an embodiment, the add number key 344 may be configured to add a new number 354 to the contact detail 345. The add number key 344 may be useful, for example, when a user receives an indication that a contact has updated their number. Further, an update number key 346 may be configured to update an old number 352 of the contact detail 345. For example, by replacing the old number 352 with the new number 354 a user of the user interface 340 may identify that the new number 354 has been updated in the contact widget 350. In an embodiment, the user interface 340 may display an always update key 348. If the always update key 348 is selected, the contact widget 350 may be automatically updated without user action. Further, the user interface 340 may be configured to allow a user to accept or deny the updated contact detail 350.

In an example embodiment, when a contact detail 345 is updated, the user interface 340 may display the new contact detail, for example, the new number 354 for a mobile phone in real time. In another example embodiment, the user interface 340 may display contact detail 345, such as a message indicating location, e.g., “On the way to the office.” If desired, the user interface 340 may additionally or alternatively display the representation 356 of the update in real time. For example, the user interface 340 may display the new number 354 and representation 356, such as a “NEW” bubble or a new box, to represent that the contact widget 350 has been updated. Further, the user interface 340 may provide an indicator of the update, for example a visual indicator, an audio indicator, e.g., a sound, a combination thereof, and/or the like.

In an embodiment, the user interface 340 may update the contact widget 350 upon communication with a contact associated with the contact widget 350. In an embodiment, the user interface 340 updates the contact widget 350 using a synchronization message. In an embodiment, synchronization of an updated contact widget, such as contact widget 350, may be performed concurrently when communication between users begins. In an embodiment, the user interface 340 may display the contact widget 350 until a second contact widget is updated. Further, the user interface 340 may communicate a message between one or more users with updated contact detail 350.

In an embodiment, the user interface 340 may be configured to allow a user to position the at least one contact widget on the user interface. For example, a user may move the contact widget 350 to a different location on the user interface 340 for a more preferred view. It should be understood that the user interface 340 may be capable of displaying any information from the contact widget 350. It should be further understood that user interface 340 may also be configured to display multiple contact widgets and/or information, such as an email address.

In an embodiment, the user interface 340 may be display the contact widget 350 until a second contact widget is updated. Further, the user interface 340 may provide a visual indicator of the update, present a sound, a combination thereof, and/or the like. In an embodiment, the user interface 340 may be configured to allow a user to position the at least one contact widget on the user interface. For example, a user may move the contact widget 350 to a different location on the user interface 340 for a more preferred view.

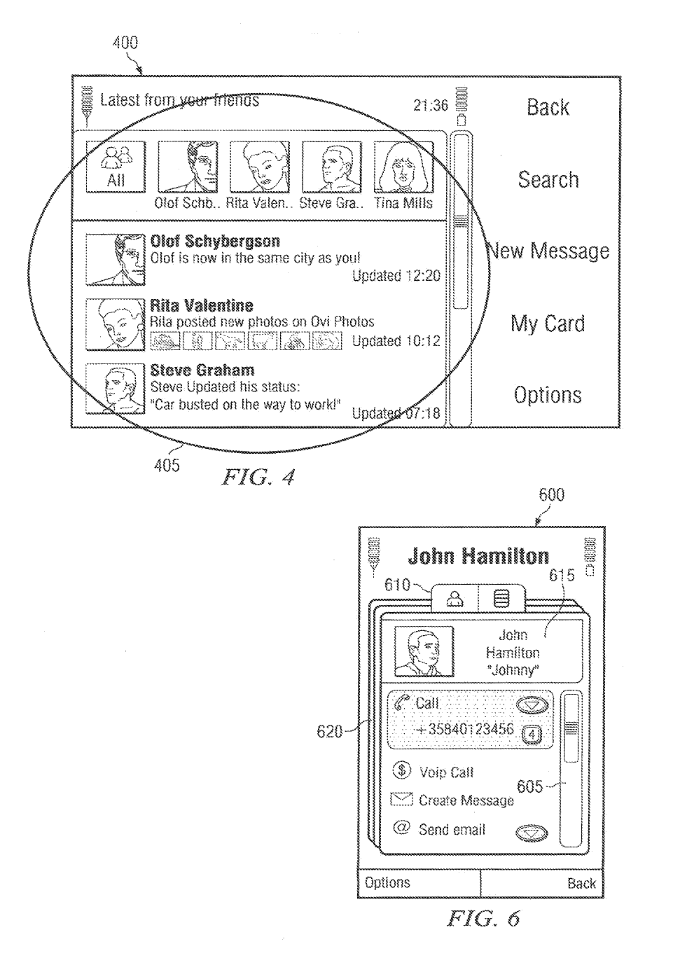

FIG. 4 is a screen view depicting contact widgets 405 in a screen saver view 400 in accordance with an example embodiment of the invention. In this example embodiment, a user interface, such as user interface 215 of FIG. 2, may be configured to display at least one of the at least one contact widget 405 in real time as a screen saver 400. For example, the screen saver 400, using an example embodiment of the invention, may display contact widgets 405 as the contact widgets become updated. In this way, a user interface may display a screen saver 400 with updated contact widgets as contact information changes, e.g., a new user location. It should be understood that the screen saver 400 may be updated with the at least one contact widget 405 in a similar manner as described throughout the specification. It should be further understood that a screen saver may be a program that displays information, such as contact widgets, after an update on a screen when an electronic device is idle. It should be also understood that the screen saver may display new information for a contact widget based at least in part on an update.

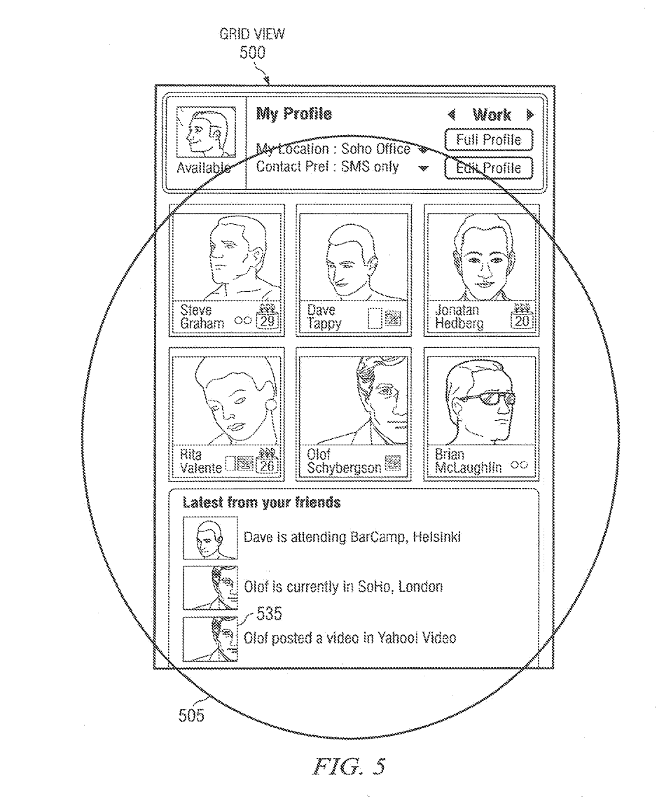

FIG. 5 is a screen view depicting contact widgets 505 in a grid view 500 according to an example embodiment of the invention. In this example embodiment, a user interface, such as user interface 215 of FIG. 2, may be configured in a grid view 500. In an embodiment, a grid view 500 may present one or more graphical user interface elements in a tabular view of data. For example, the user interface may display the contact widgets 505 and available contact detail 535 in a tabular or grid view 500. The grid view 500, using an example embodiment of the invention, may update the display of contact widgets 505 as the contact widgets become updated.

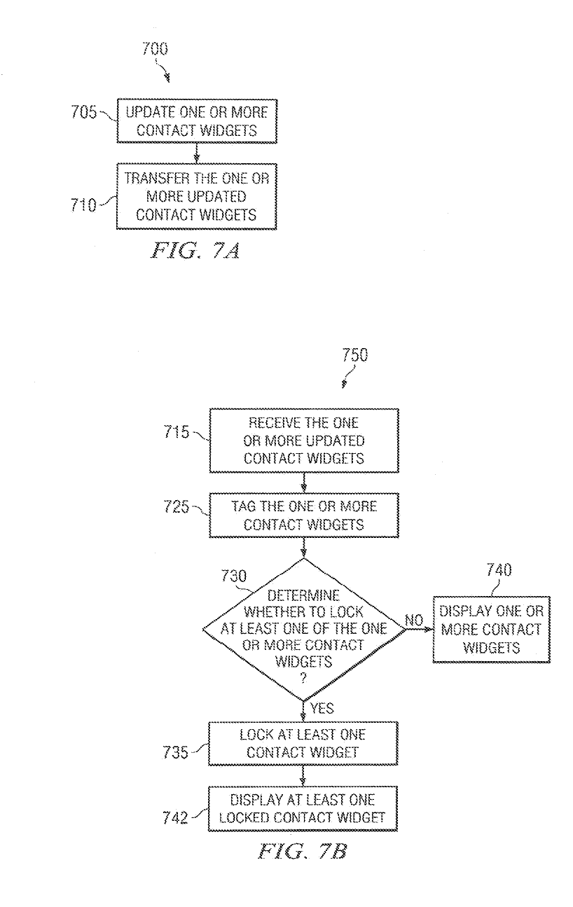

FIG. 6 is a screen view depicting a contact widget 615 in a stacked view 600 according to an example embodiment of the invention. In this example embodiment, a user interface, such as user interface 215 of FIG. 2, may be configured to display the at least one contact widget 615 in a stacked view 600. In an embodiment, the stacked view 600 may display a contact widget 615 on the user interface and one or more tabs 620 for additional contact widgets. In an embodiment, the stacked view 600 may allow a user to view additional contact widgets, e.g., a stacked contact, by selecting the corresponding tab 620. In an embodiment, the user interface may be configured to provide an indicator 610 to select a next widget from the stacked view 600. Further, the indicator 610 may be a hard key or soft key. It should be understood that a hard key may be a hard-coded key, such as a number on a key pad, the send/end key of a mobile phone, and/or the like. Further, a soft key may be a button, which performs a feature dependent on the text shown on the user interface. It should be further understood that the stacked view 600 may display updated contact widgets 615 in a similar manner as described throughout the specification.

In an alternative embodiment, the stacked view 600 may be further configured to scroll 605 the display of at least one contact widget and/or contact detail. In an embodiment, the scroll 605 may be designed as a long rectangular area on one or two sides of the viewing area, comprising a bar or the like. In an embodiment, the bar may be dragged along a track to move the body of the contact widget towards either end of the viewing area.

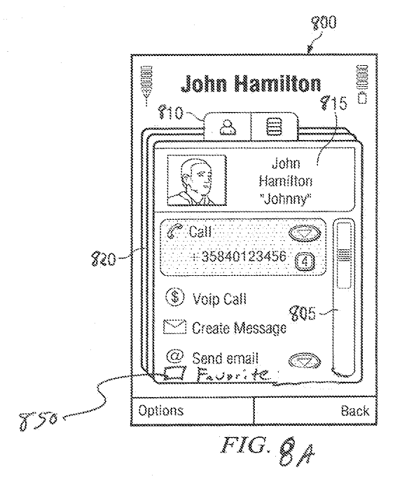

FIG. 7A is a flow diagram depicting an example method 700 for transferring one or more updated contacts in accordance with an example embodiment of the invention. Example method 700 may be performed by an electronic device, for example as electronic device 200 or 202 of FIG. 2. At 705, one or more contact widgets may be updated in real time. For example, the electronic device may update one or more contact widgets. For example, when a user changes one or more of his contact details, such as his phone number. At 710, the one or more updated contact widgets may be transferred to one or more locations. For example, the electronic device may transfer the one or more contact widgets to a second electronic device, a server, a service, and/or the like.

FIG. 7B is a flow diagram depicting an example method 750 for displaying one or more updated contacts in accordance with an example embodiment of the invention. Example method 750 may be performed by an electronic device, for example electronic device 202 of FIG. 2. At 715, the one or more updated contact widgets may be received. For example, the electronic device may receive one or more updated contact widgets from a second electronic device, such as electronic device 200 of FIG. 2, a server, a service, and/or the like.

In an embodiment, a user interface, such as user interface 240 of FIG. 2, may display one or more contact widgets based at least in part on a tag. At 725, the one or more contact widgets may be tagged. The contact widgets may be tagged, for example, based at least in part on a frequency of mobile communication, a group, a calendar entry, the update, and/or the like as discussed herein. At 730 it is determined if at least one contact widget is to be locked, e.g., to be displayed regardless of tags. In an example embodiment, this determination may be based on a user preference. If it is determined that at least one contact widget is to be locked, then at 735 at least one contact widget is locked. At 742, at least one locked contact widget is displayed. If desired, one or more contact widgets that are not locked may be displayed based at least in part on the tag.

If at 730, it is determined that none of the contact widgets are to be locked, then at 740, the one or more contact widgets may be displayed based at least in part on the tag. For example, the user interface may display the updated contact widgets, which are tagged.

In an embodiment, the user interface of the electronic device may display the one or more contact widgets as a screen saver, a stacked view, a grid view, and/or the like. In an embodiment, the user interface may also provide an indicator to select a next contact widget from the stacked view.

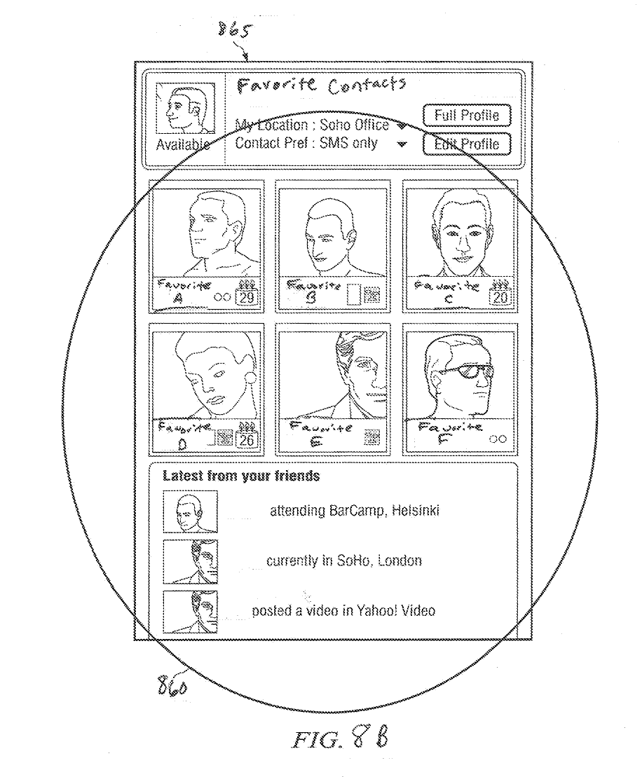

FIG. 8A is a screen view depicting a contact widget 815 in accordance with an example embodiment of the invention. In an example embodiment, a user interface, such as user interface 215 of FIG. 2, may be configured to display the at least one contact widget 815 in a stacked view 800. In an embodiment, the stacked view 800 may display a contact widget 815 on the user interface and one or more tabs 820 for additional contact widgets. In an embodiment, the stacked view 800 may allow a user to view additional contact widgets, e.g., a stacked contact, by selecting the corresponding tab 820. In an embodiment, the user interface may be configured to provide an indicator 810 to select a next widget from the stacked view 800. Further, the indicator 810 may be a hard key or soft key.

In an embodiment, the user interface is configured to display a favorite option 850 on the contact widget 815. In an embodiment, the favorite option 850 is selectable by a user. For example, a user selects the favorite option 850 thereby identifying the contact widget 815 as a favorite contact. In an example embodiment, the user interface is configured to display one or more favorite contacts.

It should be understood that the user interface may display one or more contact widget 815 in any number of views. For example, the user interface may display four contact widgets in one or more views. In an example embodiment, the user interface is configured to display the one or more contact widgets 815 in alphabetical order, chronological order, a phonebook order, and/or the like. It should be further understood that the stacked view 800 may display updated contact widget 815 in a similar manner as described throughout the specification.

FIG. 8B is a grid view 865 depicting one or more favorite contact widgets 860 in accordance with an example embodiment of the invention. In an example embodiment, a processor is configured to determine whether one or more contacts are identified as a favorite contact. For example, the processor determines whether a favorite option, such as favorite option 850 of FIG. 8A, has been selected for a contact widget. In an example embodiment, the processor is configured to determine whether one or more contacts are identified as a favorite contact in an electronic device, such as electronic device 100 of FIG. 1, phonebook. In an alternative embodiment, the processor is configured to determine whether one or more contacts are identified as a favorite contact on a subscriber identity module card.

In an example embodiment, a user interface, such as user interface 215 of FIG. 2, is configured to display the identified favorite contacts in one or more contact widgets 860 based at least in part on the determination. For example, the user interface displays contact widgets, which have been selected as favorites, e.g., the user selected a favorite option. In an example embodiment, the user interface is configured to display a photograph of the one or more contact widgets 860. For example, the user interface displays a stored photograph for a favorite contact. In an alternative embodiment, the user interface is configured to display a default image the one or more contact widgets 860. For example, the user interface displays a default image, such as a sketch, where there is no photograph for a favorite contact.

In an example embodiment, the user interface is configured to display a grid view 865. In an embodiment, the grid view 865 may present one or more graphical user interface elements in a tabular view of data. For example, the user interface may display the contact widgets 860 and available contact detail in a tabular or grid view 865. The grid view 865, using an example embodiment, may display the contact widgets 860 as the contact widgets 860 are selected as favorites.

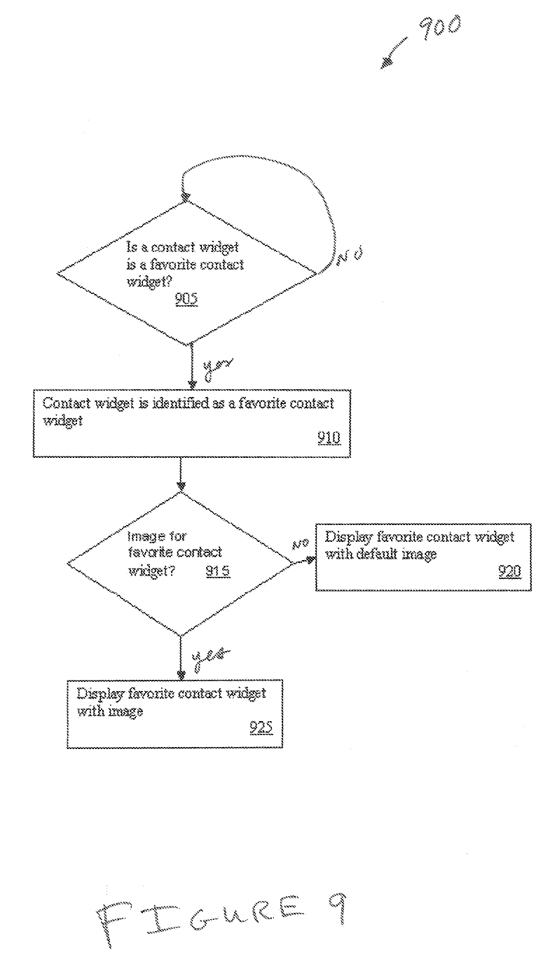

FIG. 9 is a flow diagram 900 depicting an example method for displaying one or more favorite contacts in accordance with an example embodiment of the invention. Example method 900 may be performed by an electronic device, such as electronic device 100 of FIG. 1.

At 905, it is determined whether a contact widget is a favorite contact widget. In an example embodiment, a processor is configured to determine whether one or more contacts are identified as a favorite contact.

If at 905 it is determined that a contact widget is a favorite contact widget, then at 910 the contact widget is identified as a favorite contact widget. For example, the processor determines whether a favorite option, such as favorite option 850 of FIG. 8A, has been selected for a contact widget.

If at 905 it is determined that a contact widget is not a favorite contact widget, then the example method 900 continues at 905.

At 915, it is determined whether the favorite contact widget has an image. In an example embodiment, a processor is configured to determine whether the favorite contact widget has an image. For example, the processor determines whether the favorite contact widget includes an image, e.g., a photograph of the contact.

If at 915 it determined that the favorite contact widget has an image then at 925 the favorite contact widget is displayed with the image. In an embodiment, a user interface, such as user interface 215 of FIG. 2, is configured to display an image of the favorite contact widget. For example, the user interface displays a stored photograph for the favorite contact. In an example embodiment, the user interface displays additional information, as described above, relating to the favorite contact.

If at 915, if it is determined that the favorite contact widget does an image, then at 920 the favorite contact widget is displayed with a default image. In an example embodiment, the user interface is configured to display a default image the one or more contact widgets 860. For example, the user interface displays a drawn image where there is no photograph for the favorite contact. In an example embodiment, the user interface displays additional information, as described above, relating to the favorite contact.

Without in any way limiting the scope, interpretation, or application of the claims appearing below, it is possible that a technical effect of one or more of the example embodiments disclosed herein may be updating contact widgets in real time. Another possible technical effect of one or more of the example embodiments disclosed herein may be synchronized contact widgets in an electronic device, server, and/or the like. Another technical effect of one or more of the example embodiments disclosed herein may be dynamic display of one or more contact widgets.

Embodiments of the present invention may be implemented in software, hardware, application logic or a combination of software, hardware and application logic. The software, application logic and/or hardware may reside on an electronic device or a server. If desired, part of the software, application logic and/or hardware may reside on an electronic device, and part of the software, application logic and/or hardware may reside on a server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a processor configured to determine whether one or more contacts are identified as a favorite contact; and
a user interface configured to display the identified favorite contacts in one or more contact widgets based at least in part on the determination.

2. The apparatus of claim 1 wherein the one or more contacts has a favorite option.

3. The apparatus of claim 2 wherein the favorite option is selectable by a user.

4. The apparatus of claim 1 wherein the apparatus is an electronic device or a server.

5. The apparatus of claim 1 wherein the at least one contact widget comprises at least one of the following information: a mobile number, a name, a short message service contact, a multimedia messaging service contact, an email address, a chat identifier, a location, an Internet protocol address, an Inter service provider, a voice over Internet protocol client, user profile information, one or more shared files, or combination thereof.

6. The apparatus of claim 1 wherein the user interface is further configured to display at least one of the at least one contact widget as a screen saver.

7. The apparatus of claim 1 wherein the user interface is further configured to display the at least one contact widget and at least another contact widget in a stacked view.

8. The apparatus of claim 1 wherein the user interface is further configured to provide an indicator to select a next contact widget from the stacked view.

9. The apparatus of claim 8 wherein the indicator is a hard key or soft key.

10. The apparatus of claim 1 wherein the user interface is configured to display at least one contact widget in a grid view.

11. The apparatus of claim 1 wherein the user interface is further configured to scroll contact detail for at least one contact widget.

12. A method, comprising:
determining whether one or more contacts are identified as a favorite contact; and
displaying the identified favorite contacts in one or more contact widgets based at least in part on the determination.

13. The method of claim 12 wherein the one or more contacts has a favorite option.

14. The method of claim 13 wherein the favorite option is selectable by a user.

15. The method of claim 12 wherein the apparatus is an electronic device or a server.

16. The method of claim 12 wherein the at least one contact widget comprises at least one of the following information: a mobile number, a name, a short message service contact, a multimedia messaging service contact, an email address, a chat identifier, a location, an Internet protocol address, an Inter service provider, a voice over Internet protocol client, user profile information, one or more shared files, or combination thereof.

17. The method of claim 12 wherein the user interface is further configured to display at least one of the at least one contact widget as a screen saver.

18. The method of claim 12 wherein the user interface is further configured to display the at least one contact widget and at least another contact widget in a stacked view.

19. The method of claim 12 wherein the user interface is further configured to provide an indicator to select a next contact widget from the stacked view.

20. The method of claim 19 wherein the indicator is a hard key or soft key.

21. The method of claim 12 wherein the user interface is configured to display at least one contact widget in a grid view.

22. The method of claim 12 wherein the user interface is further configured to scroll contact detail for at least one contact widget.

23. A computer program product comprising a computer-readable medium bearing computer program code embodied therein for use with a computer, the computer program code comprising:
code for determining whether one or more contacts are identified as a favorite contact; and
code for displaying the identified favorite contacts in one or more contact widgets based at least in part on the determination.

24. A computer-readable medium encoded with instructions that, when executed by a computer, perform:
determining whether one or more contacts are identified as a favorite contact; and
displaying the identified favorite contacts in one or more contact widgets based at least in part on the determination.
